(19) United States
(12) Patent Application Publication
(10) Pub. No.: US 2017/0004808 A1
(43) Pub. Date: Jan. 5, 2017

(54) METHOD AND SYSTEM FOR CAPTURING A FRAME BUFFER OF A VIRTUAL MACHINE IN A GPU PASS-THROUGH ENVIRONMENT

(71) Applicant: Nvidia Corporation, Santa Clara, CA (US)

(72) Inventors: ANIKET AGASHE, Pune (IN); SURATH RAJ MITRA, Pune (IN)

(21) Appl. No.: 14/791,075

(22) Filed: Jul. 2, 2015

(51) Int. Cl. G09G 5/36; G06F 9/445; G06F 9/455; G06T 1/20; G06T 1/60

(52) U.S. Cl. CPC G09G 5/363; G06T 1/20; G06T 1/60; G06F 9/45545; G06F 8/65; G09G 2360/18; G09G 2370/02

(57) ABSTRACT

A method for capturing information in a graphics processing unit (GPU) pass-through environment. The method includes installing a guest driver of a dedicated GPU within an assigned virtual machine. The GPU is assigned by a hypervisor configured for managing a plurality of virtual machines. The guest driver directly controls the GPU to render a plurality of frames. The method includes capturing a first frame stored in a frame buffer of the GPU. The method includes storing the first frame for later access, such as for management of the virtual machine by viewing a desktop captured in the first frame.

### BACKGROUND

Virtual machines provide for the emulation of one or more computer systems that are implemented at a back-end server system and configured for remote access. The local user only requires a low powered processing system solution to be used for accessing the back-end server system and the corresponding virtual machine. In that manner, the local user has access to a customized (e.g., high processing power) virtual machine, even though the local system has low processing power.

The back-end server system typically has a management tool that is accessible by system administrators. The standard management tools can be used for accessing the primary display outputs of the virtual machines. For example, leading virtual machine vendors provide management solutions that allow for viewing the desktops of virtual machines.

However, when remote hardware solutions are provided within a particular virtual machine, the management solutions provided by the virtual machine vendor may not be able to access the output from these remote hardware components. For example, remote graphics capabilities configured to provide graphics rendering may not be compatible with the management solutions, depending on how the remote graphics capabilities are implemented. That is, the desktop rendered by the remote graphics processing unit is not viewable using the current management solutions.

It would be beneficial to provide a solution wherein the display output of a remote graphics solution is viewable within a local or remote management solution.

### SUMMARY

In embodiments of the present invention, a computer implemented method for capturing information in a graphics processing unit (GPU) pass-through environment is disclosed. The method includes installing a guest driver of a dedicated GPU within an assigned virtual machine. The GPU is assigned by a hypervisor configured for managing a plurality of virtual machines. The guest driver directly controls the GPU to render a plurality of frames. The method includes capturing a first frame stored in a frame buffer of the GPU. The method includes storing the first frame for later access, such as for management of the virtual machine by viewing a desktop captured in the first frame.

In other embodiments of the present invention, a non-transitory computer-readable medium is disclosed having computer-executable instructions for causing a computer system to perform a method for capturing information in a GPU pass-through environment is disclosed. The method includes installing a guest driver of a dedicated GPU within an assigned virtual machine. The GPU is assigned by a hypervisor configured for managing a plurality of virtual machines. The guest driver directly controls the GPU to render a plurality of frames. The method includes capturing a first frame stored in a frame buffer of the GPU. The method includes storing the first frame for later access, such as for management of the virtual machine by viewing a desktop captured in the first frame.

In still other embodiments of the present invention, a computer system is disclosed comprising a processor and memory coupled to the processor and having stored therein instructions that, if executed by the computer system, cause the computer system to execute a method for capturing information in a GPU pass-through environment is disclosed. The method includes installing a guest driver of a dedicated GPU within an assigned virtual machine. The GPU is assigned by a hypervisor configured for managing a plurality of virtual machines. The guest driver directly controls the GPU to render a plurality of frames. The method includes capturing a first frame stored in a frame buffer of the GPU. The method includes storing the first frame for later access, such as for management of the virtual machine by viewing a desktop captured in the first frame.

In another embodiment, a virtual computing system is disclosed, wherein the system is configured for managing a plurality of virtual machines. The system includes a hypervisor or hypervisor level configured for creating and managing a plurality of virtual machines. The system includes a first virtual machine. The system includes a pool of GPUs, each of which is assignable to a virtual machine, such as in a one-to-one relationship. The system includes a guest driver of a dedicated GPU installed in the first virtual machine, wherein the guest driver directly controls the GPU to render a plurality of frames using the GPU. The dedicated GPU is assigned to the first virtual machine. The system includes a shared memory for storing a first frame rendered by the GPU, wherein the first frame is stored in the shared memory for later access.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 depicts a block diagram of an exemplary computer system suitable for implementing the present methods, in accordance with one embodiment of the present disclosure.

FIG. 2 is a block diagram of an example of a client device capable of implementing embodiments according to the present invention.

FIG. 3 is a block diagram of an example of a network architecture in which client systems and servers may be coupled to a network, according to embodiments of the present invention.

FIG. 4 is a block diagram of a host system configured for managing a plurality of virtual machines, including a virtual machine implementing remote graphics capabilities via GPU pass-through.

FIG. 5 is a flow diagram illustrating a method for capturing frame buffer information of a guest virtual machine in a GPU pass-through environment, in accordance with one embodiment of the present disclosure.

FIG. 6 is a block diagram of a host system configured for managing a plurality of virtual machines, wherein the host system is configured for capturing frame buffer information of a guest virtual machine implementing remote graphics capabilities via GPU pass-through, in accordance with one embodiment of the present disclosure.

FIG. 7 is a block diagram of a host system configured for managing a plurality of virtual machines, wherein the host system is configured for capturing frame buffer information of a guest virtual machine implementing remote graphics capabilities via GPU pass-through, and wherein the frame buffer information is delivered to a remote client over a communication network for virtual machine management, in accordance with one embodiment of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

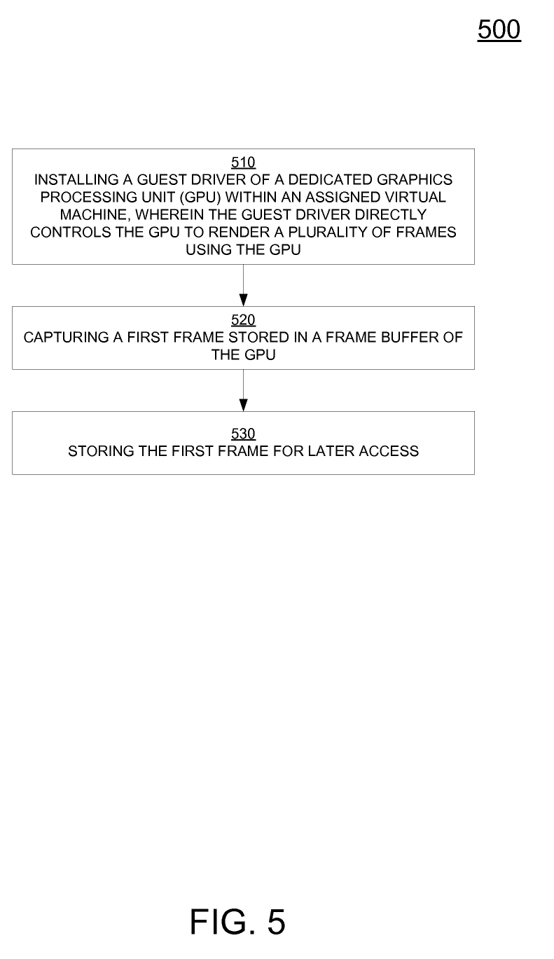

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “installing,” “capturing,” “determining,” “storing,” “accessing,” or the like, refer to actions and processes (e.g., flowchart 500 of FIG. 5) of a computer system or similar electronic computing device or processor (e.g., system 100). The computer system or similar electronic computing device manipulates and transforms data represented as physical (electronic) quantities within the computer system memories, registers or other such information storage, transmission or display devices.

FIG. 5 is a flowchart of examples of computer-implemented methods for capturing information in a GPU pass-through environment according to embodiments of the present invention. Although specific steps are disclosed in the flowcharts, such steps are exemplary. That is, embodiments of the present invention are well-suited to performing various other steps or variations of the steps recited in the flowcharts.

Other embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

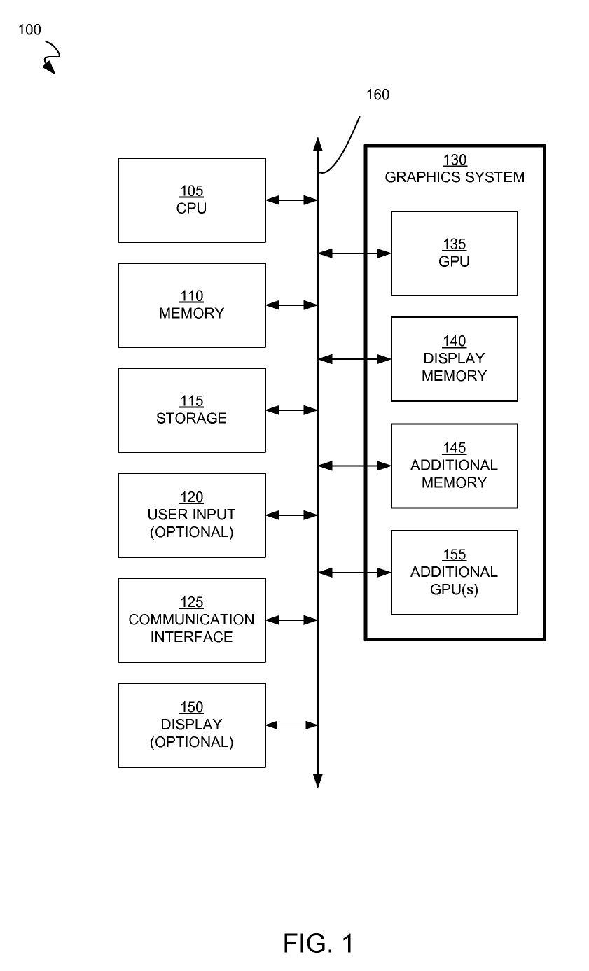

FIG. 1 is a block diagram of an example of a computing system 100 capable of implementing embodiments of the present disclosure. Computing system 100 broadly represents any single or multi-processor computing device or system capable of executing computer-readable instructions. Examples of computing system 100 include, without limitation, workstations, laptops, client-side terminals, servers, distributed computing systems, handheld devices, or any other computing system or device. In one embodiment, computing system 100 is implemented within a server environment that is configured for creating and managing a plurality of virtual machines. In its most basic configuration, computing system 100 may include at least one processor 105 and a system memory 110.

It is appreciated that computer system 100 described herein illustrates an exemplary configuration of an operational platform upon which embodiments may be implemented to advantage. Nevertheless, other computer system with differing configurations can also be used in place of computer system 100 within the scope of the present invention. That is, computer system 100 can include elements other than those described in conjunction with FIG. 1. Moreover, embodiments may be practiced on any system which can be configured to enable it, not just computer systems like computer system 100. It is understood that embodiments can be practiced on many different types of computer systems 100. System 100 can be implemented as, for example, a desktop computer system or server computer system having powerful, general-purpose CPUs coupled to a dedicated graphics rendering GPU (local or remote). In such an embodiment, components can be included that add peripheral buses, specialized audio/video components, I/O devices, and the like. Similarly system 100 can be implemented as a handheld device (e.g., cell phone, etc.) or a set-top video game console device, such as, for example Xbox®, available from Microsoft corporation of Redmond, Washington, or the PlayStation3®, available from Sony Computer Entertainment Corporation of Tokyo, Japan. System 100 can also be implemented as a “system on a chip”, where the electronics (e.g., the components 105, 110, 115, 120, 125, 130, 150, and the like) of a computing device are wholly contained within a single integrated circuit die. Examples include a hand-held instrument with a display, a car navigation system, a portable entertainment system, and the like.

In the example of FIG. 1, the computer system 100 includes a central processing unit (CPU) 105 for running software applications and optionally an operating system. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones. In one embodiment, the components of computer system 100 is implementable within a virtual machine.

The communication or network interface 125 allows the computer system 100 to communicate with other computer systems via an electronic communications network, including wired and/or wireless communication and including the Internet. The optional display device 150 may be any device capable of displaying visual information in response to a signal from the computer system 100. The components of the computer system 100, including the CPU 105, memory 110, data storage 115, user input devices 120, communication interface 125, and the display device 150, may be coupled via one or more data buses 160.

In the embodiment of FIG. 1, a graphics system 130 may be coupled with the data bus 160 and the components of the computer system 100. The graphics system 130 may include a physical graphics processing unit (GPU) 135 and graphics memory. The GPU 135 generates pixel data for output images from rendering commands. The physical GPU 135 can be configured as multiple virtual GPUs that may be used in parallel (concurrently) by a number of applications executing in parallel. In another embodiment, the graphics system 130 may be a dedicated system that is remote from and assigned to a corresponding virtual machine, such as that implemented by computer system 100.

For example, graphics memory may include a display memory 140 (e.g., a frame buffer) used for storing pixel data for each pixel of an output image. In another embodiment, the display memory 140 and/or additional memory 145 may be part of the memory 110 and may be shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 may be adapted to operate in parallel with the GPU 135. Each additional GPU 155 generates pixel data for output images from rendering commands. Each additional physical GPU 155 can be configured as multiple virtual GPUs that may be used in parallel (concurrently) by a number of applications executing in parallel. Each additional GPU 155 can operate in conjunction with the GPU 135 to simultaneously generate pixel data for different portions of an output image, or to simultaneously generate pixel data for different output images.

Each additional GPU 155 can be located on the same circuit board as the GPU 135, sharing a connection with the GPU 135 to the data bus 160, or each additional GPU 155 can be located on another circuit board separately coupled with the data bus 160. Each additional GPU 155 can also be integrated into the same module or chip package as the GPU 135. In still other embodiments, each additional GPU can be located in a GPU source pool, wherein one or more GPUs are allocated to a virtual machine. Each additional GPU 155 can have additional memory, similar to the display memory 140 and additional memory 145, or can share the memories 140 and 145 with the GPU 135.

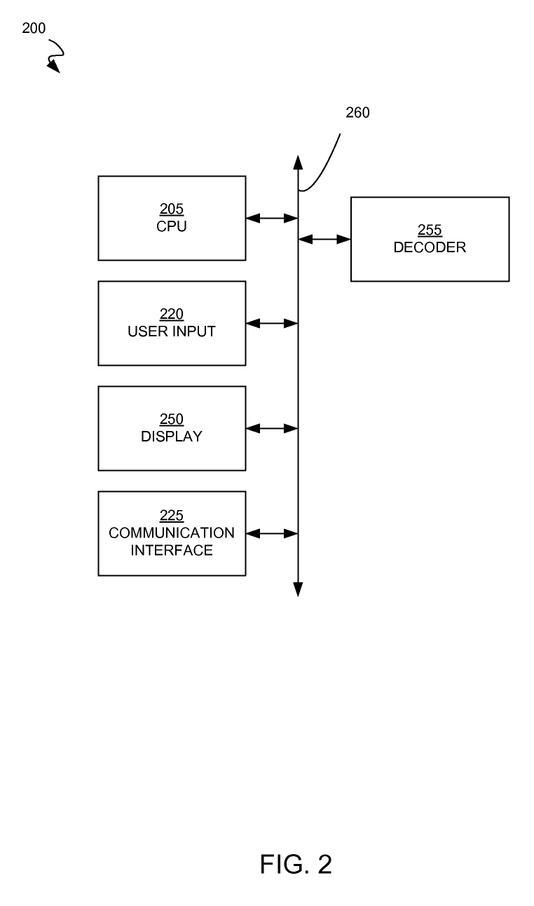

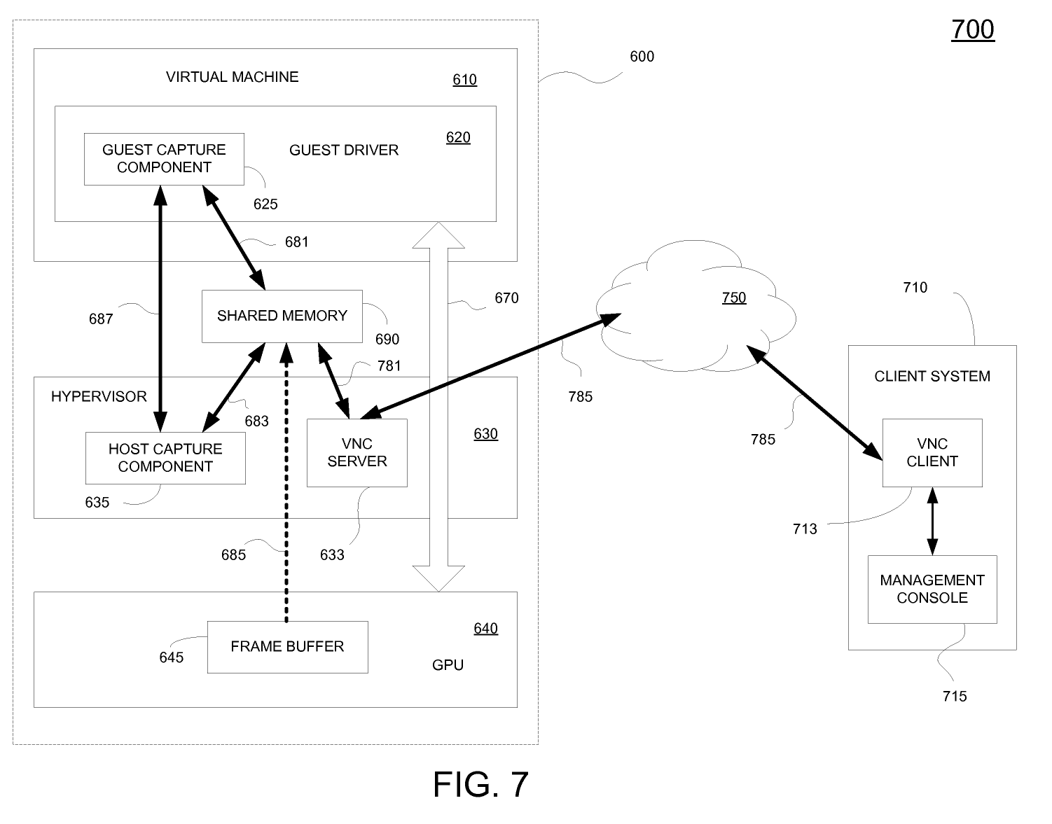

FIG. 2 is a block diagram of an example of an end user or client device 200 capable of implementing embodiments according to the present invention. In one example, client device 200 is configured to provide management control of a virtual machine by gaining access to the primary display output of a remote GPU implemented through a GPU pass-through environment. In another embodiment, the client device 200 is a thin client used for accessing the output from a corresponding virtual machine. In still another embodiment, client device 200 may be a virtual network computing (VNC) device, such as those described in FIG. 7.

In the example of FIG. 2, the client device 200 includes a CPU 205 for running software applications and optionally an operating system. The user input 220 includes devices that communicate user inputs from one or more users and may include keyboards, mice, joysticks, touch screens, and/or microphones.

The communication interface 225 allows the client device 200 to communicate with other computer systems (e.g., the computer system 100 of FIG. 1) via an electronic communications network, including wired and/or wireless communication and including the Internet. The decoder 255 may be any device capable of decoding (decompressing) data that may be encoded (compressed). For example, the decoder 255 may be an H.264 decoder. The display device 250 may be any device capable of displaying visual information, including information received from the decoder 255. The display device 250 may be used to display visual information generated at least in part by the client device 200. However, the display device 250 may be used to display visual information received from the computer system 100. The components of the client device 200 may be coupled via one or more data buses 260. Further, the components may or may not be physically included inside the housing of the client device 200. For example, the display 250 may be a monitor that the client device 200 communicates with either through cable or wirelessly.

Relative to the computer system 100, the client device 200 in the example of FIG. 2 may have fewer components and less functionality and, as such, may be referred to as a thin client. In general, the client device 200 may be any type of device that has display capability, the capability to decode (decompress) data, and the capability to receive inputs from a user and send such inputs to the computer system 100. However, the client device 200 may have additional capabilities beyond those just mentioned. The client device 200 may be, for example, a personal computer, a tablet computer, a television, a hand-held gaming system, or the like.

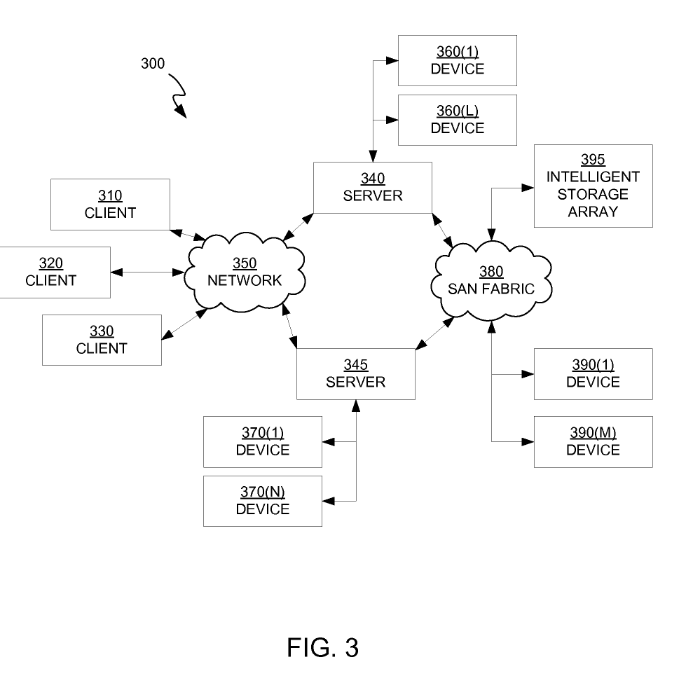

FIG. 3 is a block diagram of an example of a network architecture 300 in which client systems 310, 320, and 330 and servers 340 and 345 may be coupled to a network 350. Client systems 310, 320, and 330 generally represent any type or form of computing device or system, such as computing system 110 of FIG. 1 and/or client device 200 of FIG. 2.

Similarly, servers 340 and 345 generally represent computing devices or systems, such as application servers, GPU servers, or database servers, configured to provide various database services and/or run certain software applications. Network 350 generally represents any telecommunication or computer network including, for example, an intranet, a wide area network (WAN), a local area network (LAN), a personal area network (PAN), or the Internet.

With reference to computing system 100 of FIG. 1, a communication interface, such as communication interface 125, may be used to provide connectivity between each client system 310, 320, and 330 and network 350. Client systems 310, 320, and 330 may be able to access information on server 340 or 345 using, for example, a web browser or other client software. In that manner, client systems 310, 320, and 330 are configurable to access servers 340 and/or 345 that provide for graphics processing capabilities, thereby off-loading graphics processing to the back end servers 340 and/or 345 for purposes of display at the front end client systems 310, 320, and 330. Further, such software may allow client systems 310, 320, and 330 to access data hosted by server 340, server 345, storage devices 360(1)-(L), storage devices 370(1)-(N), storage devices 390(1)-(M), or intelligent storage array 395. Although FIG. 3 depicts the use of a network (such as the Internet) for exchanging data, the embodiments described herein are not limited to the internet or any particular network-based environment.

In one embodiment, all or a portion of one or more of the example embodiments disclosed herein are encoded as a computer program and loaded onto and executed by server 340, server 345, storage devices 360(1)-(L), storage devices 370(1)-(N), storage devices 390(1)-(M), intelligent storage array 395, or any combination thereof. All or a portion of one or more of the example embodiments disclosed herein may also be encoded as a computer program, stored in server 340, run by server 345, and distributed to client systems 310, 320, and 330 over network 350.

### Methods and Systems for a GRID Architecture Providing Cloud Based Virtualized Graphics Processing for Remote Displays

Embodiments of the present invention provide for the capture of frame buffer information of a guest virtual machine that is configured with remote graphics capabilities from a dedicated GPU accessed via GPU pass-through. Though GPU pass-through bypasses any corresponding hypervisor and its control functionality, embodiments of the present invention provide for the continued use of virtual machine management tools that are implemented with the hypervisor.

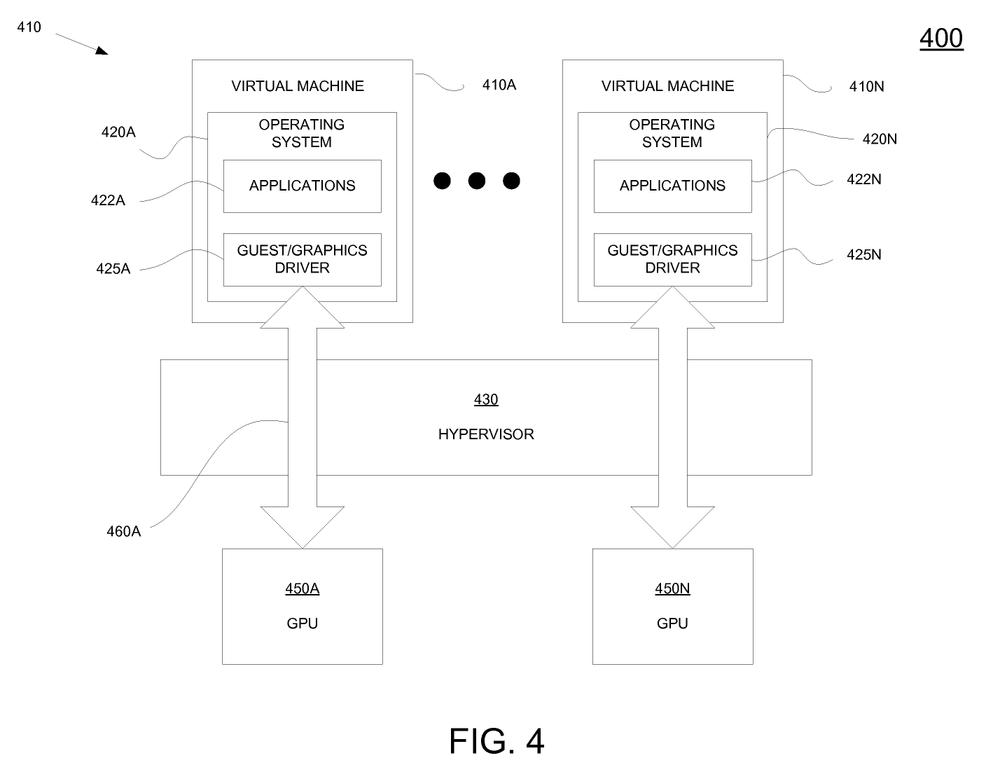

FIG. 4 illustrates a host system 400 configurable for implementing cloud or network based virtualized graphics processing for remote displays (not shown) using GPU pass-through, or any other technique providing remote hardware capabilities (e.g., graphics) for a virtual machine. As shown, host system 400 includes a hypervisor 430 that is configured for creating and/or managing a plurality of virtual machines 410 (e.g., 410A-N) that are accessible by remote users. For example, the hypervisor 430 presents one or more guest operating systems 420A-N within a virtual operating platform. That is, hypervisor 430 is configured to manage the execution of each guest operating system, and as such hypervisor 430 is able to virtually assign and distribute the physical resources (e.g., processors, etc.) (not shown) based on the needs of users accessing the plurality of virtual machines 420.

A virtual machine is described using virtual machine 410A as a representative example. Virtual machine 410A includes a guest operating system 420A that manages hardware and software resources to execute one or more applications 422A. Application 422A can be any type of application, including those that rely heavily on graphics processing, such as a video game application, an application providing financial services, an application providing computer aided design (CAD) services, etc.

In addition, virtual machine 410A includes a guest/graphics driver 425A that is installed within the operating system 420A. The guest/graphics driver 420A controls hardware resources on a remotely located GPU 450A in order to provide remote graphics capabilities to the operating system 420A. In one embodiment, a GPU 450A unit is assigned and dedicated to virtual machine 410A in a one-to-one relationship by hypervisor 430. In that manner, GPU 450A is not controlled by the hypervisor 430. For example, a GPU pass-through technique 460A is able to directly connect a physical GPU to a virtual machine. However, the GPU pass-through 460A prevents the hypervisor 430 from accessing the primary display output of the GPU 450A, which may be critical when implementing management tools through the hypervisor 430. Embodiments of the present invention provide for the capture and display of the display output of the GPU 450A in a GPU pass-through environment that is accessible by one or more components, such as hypervisor 430.

Virtual machines in the plurality of virtual machines 410 are similarly configured. For instance, virtual machine 410N includes a guest operating system 420N that is configured to execute application 422N. Also, the guest/graphics driver 425N is installed within operating system 420N, to control hardware resources on a remotely located GPU 450N in order to provide remote graphics capabilities to the operating system 420N. In one implementation, the GPU 450N unit is assigned and dedicated to virtual machine 410N in a one-to-one relationship by hypervisor 430.

FIG. 5 is a flow diagram 500 illustrating a method for capturing frame buffer information of a guest virtual machine in a GPU pass-through environment, in accordance with one embodiment of the present disclosure. In another embodiment, flow diagram 500 illustrates a computer implemented method for capturing frame buffer information of a guest virtual machine in a GPU pass-through environment. In still another embodiment, flow diagram 500 is implemented within a computer system including a processor and memory coupled to the processor and having stored therein instructions that, if executed by the computer system causes the system to execute a method for capturing frame buffer information of a guest virtual machine in a GPU pass-through environment. In still another embodiment, instructions for performing a method are stored on a non-transitory computer-readable storage medium having computer-executable instructions for causing a computer system to perform a method for capturing frame buffer information of a guest virtual machine in a GPU pass-through environment. The method outlined in flow diagram 500 is implementable by one or more components of the computer system 100 of FIG. 1.

At 510, the method includes installing a guest driver of a dedicated GPU, wherein the GPU is assigned to a corresponding virtual machine associated with the guest driver by a hypervisor that manages a plurality of virtual machines. The guest driver directly controls the GPU to render a plurality of frames for the virtual machine. The GPU provides remote graphics capabilities to the virtual machine, and is communicatively connected to the operating system of the virtual machine through a direct connection, thereby bypassing the hypervisor. For example, GPU pass-through is implemented to allow the guest driver to directly control the GPU. In that manner, the guest driver manages the GPU resources (e.g., frame buffer) and controls rendering of frames when executing a corresponding application. As a result, the hypervisor has no information about the guest frame buffer associated with the GPU, and the resulting desktop image that is rendered.

At 520, the method includes capturing a first frame stored in a frame buffer of the GPU. That is, after a first frame is rendered and stored in the frame buffer of the GPU, the guest driver is configured to send instructions to the GPU for the capture of the first frame. For example, a “GPU Copy” may be enabled by the guest driver in order to copy the information located in a corresponding frame buffer.

At 530, the method includes storing the first frame for later access. For example, the first frame is stored in a memory location that is accessible by one or more entities. In one embodiment, the guest driver is able to access the first frame in the memory location. In another embodiment, the hypervisor is able to access the first frame in the memory location. In that manner, the hypervisor is able to execute virtual machine management tools on the display output of the GPU, even though the display output originally bypasses the hypervisor. For instance, the desktop of the virtual machine as rendered by the GPU is viewable by the virtual machine management tools executing on the hypervisor.

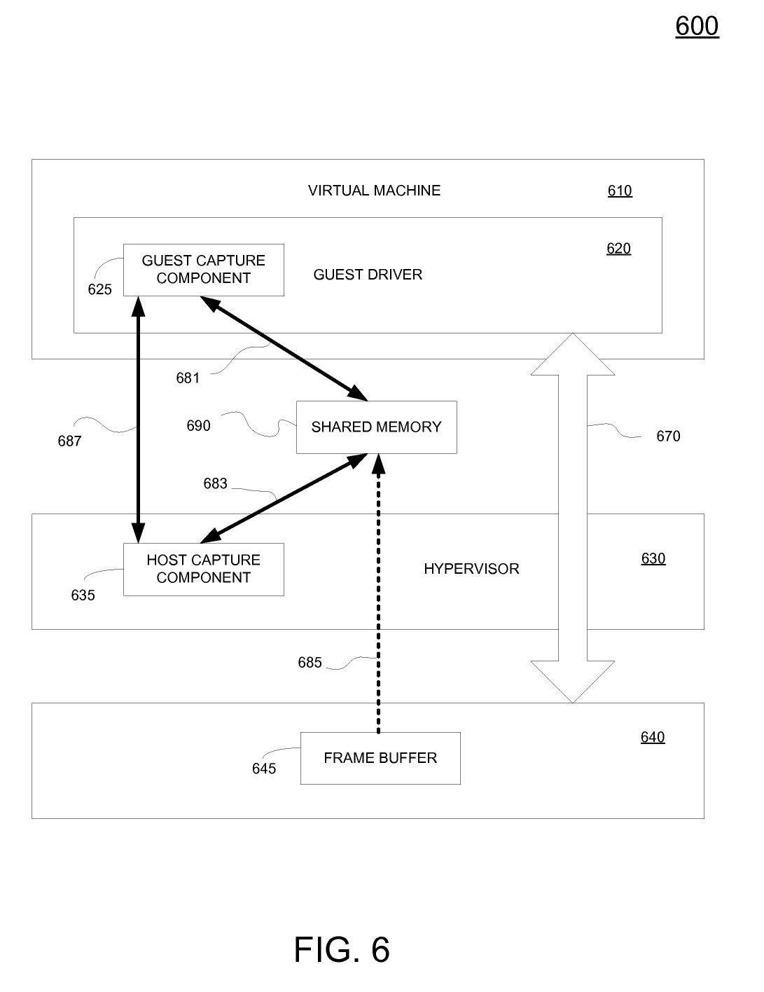

Additional operations performed within the method outlined in flow diagram 500 is described within the context of a host system, such as the host system 600 of FIG. 6, as described below.

FIG. 6 is a block diagram of a host system 600 configured for implementing cloud or network based virtualized graphics processing for remote displays (not shown) using a dedicated GPU (e.g., via GPU pass-through). The host system 600 is configured for capturing frame buffer information of a guest virtual machine 610 implementing remote graphics capabilities via GPU pass-through 670, in accordance with one embodiment of the present disclosure. In one embodiment, host system 600 is configured to implement the method of flow diagram 500 of FIG. 5 to perform a method for capturing frame buffer information of a guest virtual machine in a GPU pass-through environment 670.

The hypervisor 630 is configured for creating and/or managing a plurality of virtual machines, including virtual machine 610. As shown, hypervisor 630 presents the operating system of the virtual machine 610 to a remote user. More specifically, hypervisor 630 is configured to manage the execution of the guest operating system in the virtual machine 610. For example, hypervisor 630 is able to manage the operations of the resources available to the virtual machine.

In one embodiment, the virtual machine 610 includes remote graphics capabilities that are not managed by hypervisor 630. That is, a dedicated GPU 640 is made available to the virtual machine 610, and is implemented by installing the guest/graphics driver on the virtual machine 610. For example, the dedicated GPU may be part of a server pool of GPU resources, wherein the GPU resources are not normally made available for allocation by the hypervisor 630. As such, the driver 620 is configured to directly control the hardware resources of the GPU 640 to render a plurality of graphical frames (e.g., desktop) for the virtual machine 610. In that manner, control by the hypervisor 630 of the GPU 640 is bypassed.

In one embodiment, the GPU 640 is communicatively coupled to the virtual machine 610 through a direct connection, thereby bypassing the hypervisor. For example, GPU pass-through is implemented to allow the guest driver 620 to directly control the GPU 640.

The host system 600 is configured to capture a frame buffer of a guest virtual machine that is implementing remote graphics capabilities in a GPU pass-through environment 670. In particular, a guest capture component 625 is instantiated and/or executing within the guest driver 620 of the virtual machine 610. In addition, a host capture component 635 is also instantiated and/or executing within the hypervisor 630. The guest capture component 625 is configured to communicate with the host capture component 635 using an inter-domain management channel 687, such as one associated with and managed by hypervisor 630.

A shared system memory 690 (e.g., system memory or random access memory [RAM]) is also instantiated within host system 600. The shared system memory 690 is accessible by the guest driver 620 via the guest capture component 625 over communication path 681. Also, the shared system memory 690 is accessible by the hypervisor via the host capture component 635 over communication path 683. In particular, when the guest driver 620 loads, the guest capture component 625 is configured to communicate with the host capture component 635 executing in the hypervisor 630 over the inter-domain management channel 687 to instantiate the shared system memory 690. Access to the shared system memory 690 by the guest driver capture component 625 and/or the host capture component 635 is enabled using a hypervisor specific mechanism, in one implementation.

More specifically, when the guest driver 620 updates the guest desktop, the guest driver capture component 625 is configured to instruct the GPU 640 to copy the updated desktop content from the GPU frame buffer 645, where it is temporarily stored, to the shared memory 690. The copy process is performed over communication path 685 between the frame buffer 645 and the shared memory 690. For instance, the copy process uses a GPU copy engine located in the GPU 640. This ensures that central processing unit (CPU) overhead at the virtual machine is minimized during the copy process. Of course, other copy methodologies are supported in order to copy the frame buffer information.

Because the guest driver 620 manages and controls the execution of the GPU 640, the guest driver is aware of when the latest frame is rendered by the GPU and stored in the frame buffer 645. Correspondingly, that information is relayed to the guest driver capture component 625. For instance, in one implementation the guest capture component 625 is configured to monitor GPU control traffic between the guest driver 620 and the GPU 640. In another implementation, the guest driver 620 provides notification of the rendering of the particular frame to the guest capture component 625. In this manner, the guest capture component 625 is able to determine when a particular frame is rendered and temporarily stored in the frame buffer 645. Thereafter, the guest capture component 625 is configured to send an instruction to the GPU 640 (e.g., via the guest drier 620 using GPU pass-through) to copy the particular frame stored in the frame buffer 645 into the shared memory via path 685.

In addition, the guest driver capture component 625 delivers a notification to the host capture component 635 that the particular frame is captured and stored in the shared memory 690 via the inter-domain management channel 687. That is, the guest driver capture component 625 sends an event to the host capture component 635 via path 687 indicating that the newly captured information (e.g., desktop surface rendered by the GPU 640) is available in the shared memory 690.

As such, the hypervisor 630 is able to access and monitor the display output provided by the GPU 640, such as through the host capture component 635. In this manner, hypervisor management tools are able to access and monitor the primary display output (e.g., desktop) of the virtual machine as rendered by the GPU 640 by accessing the relevant frames in the shared memory 690.

FIG. 7 is a block diagram of a host system 700 configured for managing a plurality of virtual machines, wherein the host system is configured for capturing frame buffer information of a guest virtual machine 610 implementing remote graphics capabilities via GPU pass-through, and wherein the frame buffer information is delivered to a remote client system 710 over a communication network 750 for virtual machine management, in accordance with one embodiment of the present disclosure. FIG. 7 implements host machine 600 first introduced in FIG. 6, with a slight modification, such that a virtual network computing (VNC) server 633 is included at the hypervisor level 630, and enabled for communicating with a remotely located client system 710 for purposes of remote virtual machine management. As such, similarly labeled components of the host system 600 shown in FIGS. 6-7 have similar functionality. That is, the host system 600 of FIGS. 6-7 has the capability of capturing frame buffer information of a guest virtual machine 610 implementing remote graphics capabilities via GPU pass-through.

As shown in FIG. 7, the host system 600 includes a VNC server 633 that is communicatively coupled to the shared memory 690 via communication path 781. As shown the VNC server 633 executing on the hypervisor 630 is able to access a particular frame (e.g., a desktop frame image) rendered by GPU 640 and stored in the shared memory 690 via communication path 681, and pass it over a communication network 750 via communication path 785 to a VNC client 713 of a client system 710. In this manner the information (e.g., desktop) may be displayed in a management console 715 (e.g., XenCenter from XenServer provided by Citrix Systems, Inc.) that is executing a management tool for purposes of remotely managing the virtual machine 610.

For example, in one implementation, a request is delivered from the VNC server 633 to the host capture component 635 via an internal hypervisor communication channel for a particular frame that was rendered by the GPU 640. The host capture component 635 in hypervisor 630 sends a memory location in the shared memory 690 that contains the particular frame back to the VNC server 633. As a result, the VNC server 633 receives a memory location in the shared memory that contains and/or stores the particular frame. Thereafter, the VNC server 633 is able to deliver that particular frame over path 785 to the VNC client 713, as previously described.

Thus, according to embodiments of the present disclosure, systems and methods are described providing for frame buffer capture of a guest virtual machine in a GPU pass-through environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the present disclosure are thus described. While the present disclosure has been described in particular embodiments, it should be appreciated that the disclosure should not be construed as limited by such embodiments, but rather construed according to the below claims.

What is claimed:

1. A system comprising:
a processor; and
non-transitory memory coupled to said processor and having stored therein instructions that, if executed by said computer system, cause said computer system to execute a method for capturing information comprising:
installing a guest driver of a dedicated graphics processing unit (GPU) within an assigned virtual machine, wherein said guest driver directly controls said GPU to render a plurality of frames for said virtual machine;
capturing a first frame stored in a frame buffer of said GPU; and
storing said first frame for later access.

2. The system of claim 1, wherein said method further comprises:
implementing GPU pass-through to allow said guest driver to directly control said GPU.

3. The system of claim 1, wherein said method further comprises:
initializing a guest capture component in said guest driver, wherein said guest capture component is configured for communicating over an inter-domain management channel with a host capture component at a hypervisor, wherein said hypervisor manages a plurality of virtual machines.

4. The system of claim 3, wherein said method further comprises:
at said guest capture component, monitoring GPU control traffic between said guest driver and said GPU;
determining when said first frame is rendered in said GPU and correspondingly stored in said frame buffer; and
sending an instruction to said GPU to copy said first frame into said shared memory that is accessible by said guest capture component and said host capture component, wherein said guest capture component controls said capturing and storing.

5. The system of claim 4, wherein said method further comprises:
notifying said host capture component that said first frame is captured and stored.

6. The system of claim 3, wherein said storing said first frame in said method comprises:
establishing shared memory that is accessible by said guest capture component and said host capture component; and
storing said first frame in said shared memory.

7. The system of claim 3, wherein said method further comprises:
accessing said first frame from said shared memory by a virtual network computing (VNC) server running at said hypervisor; and
sending said first frame to a VNC client over a communication network, wherein said VNC client is configured for remote management of said virtual machine.

8. The system of claim 7, wherein said method further comprises:
sending from said VNC server a request for said first frame to said host capture component; and
receiving at said VNC server from said host capture component a memory location in said shared memory that is storing said first frame.

9. A non-transitory computer-readable medium having computer-executable instructions for causing a computer system to perform a method for capturing information comprising:
installing a guest driver of a dedicated graphics processing unit (GPU) within an assigned virtual machine, wherein said guest driver directly controls said GPU to render a plurality of frames for said virtual machine;
capturing a first frame stored in a frame buffer of said GPU; and
storing said first frame for later access.

10. The method of claim 9, further comprising:
implementing GPU pass-through to allow said guest driver to directly control said GPU.

11. The method of claim 9, further comprising:
initializing a guest capture component in said guest driver, wherein said guest capture component is configured for communicating over an inter-domain management channel with a host capture component at a hypervisor, wherein said hypervisor manages a plurality of virtual machines.

12. The method of claim 11, further comprising:
at said guest capture component, monitoring GPU control traffic between said guest driver and said GPU;
determining when said first frame is rendered in said GPU and correspondingly stored in said frame buffer; and
sending an instruction to said GPU to copy said first frame into said shared memory that is accessible by said guest capture component and said host capture component, wherein said guest capture component controls said capturing and storing.

13. The method of claim 12, further comprising:
notifying said host capture component that said first frame is captured and stored.

14. The method of claim 11, wherein said storing said first frame comprises:
establishing shared memory that is accessible by said guest capture component and said host capture component; and
storing said first frame in said shared memory.

15. The method of claim 11, further comprising:
accessing said first frame from said shared memory by a virtual network computing (VNC) server running at said hypervisor; and
sending said first frame to a VNC client over a communication network, wherein said VNC client is configured for remote management of said virtual machine.

16. The method of claim 15, further comprising:
sending from said VNC server a request for said first frame to said host capture component; and
receiving at said VNC server from said host capture component a memory location in said shared memory that is storing said first frame.

17. A virtual computing system, comprising:
a hypervisor configured for managing a plurality of virtual machines;
a first virtual machine;
a pool of graphics processing units (GPUs);
a guest driver of a dedicated GPU installed in said first virtual machine, wherein said dedicated GPU is assigned to said first virtual machine, wherein said guest driver directly controls said GPU to render a plurality of frames for said virtual machine; and
a shared memory for storing a first frame rendered by said GPU, wherein said first frame is stored in said shared memory for later access.

18. The virtual computing system of claim 17, further comprising:
a guest capture component in said guest driver configured for monitoring GPU control traffic between said guest driver and said GPU, and for determining when said first frame is rendered in said GPU and correspondingly stored in said frame buffer;
a host capture component in said hypervisor configured for accessing said first frame; and
an inter-domain management channel configured for enabling communication between said guest capture component and said host capture component, wherein said guest capture component is configured for sending an instruction to said GPU to copy said first frame into said shared memory that is accessible by said guest capture component and said host capture component.

19. The virtual computing system of claim 18, wherein said guest capture component is configured for notifying said host capture component over said inter-domain management channel that said first frame is captured and stored in said shared memory.

20. The virtual computing system of claim 18, further comprising:
a virtual network computing (VNC) server running at said hypervisor and configured for accessing said first frame from said shared memory, and for delivering said first frame to a VNC client over a communication network, wherein said VNC client is configured for remote management of said virtual machine.
